(19) United States
(12) Patent Application Publication
(10) Pub. No.: US 2014/0108056 A1
(43) Pub. Date: Apr. 17, 2014

(54) COMPLETE CONSENT

(71) Applicant: Complete Consent LLC, Savannah, GA (US)

(72) Inventor: Sidney P. Smith, Savannah, GA (US)

(73) Assignee: Complete Consent LLC, Savannah, GA (US)

(21) Appl. No.: 14/140,778

(22) Filed: Dec. 26, 2013

Related U.S. Application Data
(63) Continuation-in-part of application No. 13/135,731, filed on Jul. 14, 2011, now abandoned.
(60) Provisional application No. 61/475,710, filed on Apr. 15, 2011.

(51) Int. Cl. G06Q 50/24; G06Q 10/00

(52) U.S. Cl. CPC G06Q 50/24; G06Q 10/00
USPC 705/3

(57) ABSTRACT

Signing an informed consent can be recorded and archived for future reference. A reason may be discovered for signing a second informed consent based on a parcel of additional or changed information. After updating the informed consent to a second informed consent, a patient signing the second informed consent is also recorded. The informed consent may also be modified to take into account characteristics of the patient that may affect the patient's ability to understand the informed consent.

### CROSS-REFERENCES TO RELATED APPLICATIONS

This application is a continuation-in-part of U.S. patent application Ser. No. 13/135,731, filed Jul. 14, 2011, pending, which claims the benefit of U.S. Provisional Patent Application Ser. No. 61/475,710, filed Apr. 15, 2011, the entire contents of each of which are hereby incorporated by reference in this application.

### STATEMENT REGARDING FEDERALLY SPONSORED RESEARCH OR DEVELOPMENT

(NOT APPLICABLE)

### BACKGROUND OF THE INVENTION

Historically, informed consent consists of a form that discloses drugs or medical treatment a patient is to receive. The problem with this approach is that once the informed consent is signed by the patient it is stored in a file and rarely looked at again. There may be changes to the informed consent form due to changes in the drugs or medical treatment a patient is receiving. The old forms are discarded and new forms are put into place. This scenario may occur several times during the course of a year. This approach does nothing for the patients who have signed old forms. Their forms generally are not updated until they return to the physician's office for further treatment.

Some physicians capture the entire informed consent signature process via video and store the video on a database. The problem still exists of how to follow up on patients whose informed consents were obtained on video presentations that have been replaced by more recent patient information concerning their particular drugs or medical treatments.

It would be desirable to have an informed consent process that is video captured and stored in a video library. The library would maintain the videos including scanning the informed consent form electronically to determine the information thereon and to see if they are in need of updating. There is no process where the Federal Drug Administration (FDA) can monitor what information/consents have been received by patient nor is there a process where patients can be contacted with medically or surgically significant updates from the FDA.

### BRIEF SUMMARY OF THE INVENTION

The present invention is a software program FIG. 1, element 10 that resides in the memory of a computer network. The computer network has a server that is in communication with a plurality of client computers, IPads or personal electronic devices. The client computers reside in doctors' offices, clinics, hospitals, universities and personal electronic devices. The server facilitates the command and control of a library or archive 11 of drug, medical treatment and surgical procedure information and the distribution of information to client computers upon request.

For each drug there is a video 12, written consent 13, patient information handouts 14, laboratory flow sheets 15 and orders for the laboratory. For medical/surgical procedures, the server has a video of the medical/surgical procedures, written consent, patient information handouts, laboratory flow sheets and orders for the laboratory.

When taken in conjunction with the accompanying drawings and the appended claims, other features and advantages of the present invention become apparent upon reading the following detailed description of embodiments of the invention.

### BRIEF DESCRIPTION OF THE DRAWINGS

The invention is illustrated m the drawings in which like reference characters designate the same or similar parts throughout the Figures of which:

FIG. 1 illustrates a top-level block diagram view of a present invention,

FIG. 2 illustrates a top-level block diagram view of a complete informed consent of FIG. 1,

FIG. 3 illustrates a top-level block diagram view of a process to video capture the discussion with a Physician of FIG. 1.

### DETAILED DESCRIPTION OF THE INVENTION

Before describing in detail the particular improved system architecture for informed consent and pharmaceutical interaction in accordance with the present invention, it should be observed that the invention resides primarily in the novel data structures of the system software and not in the combination of conventional system apparatus. Examples of a system apparatus are a computer, database, telephone network, PBX system or a communication system linking the system apparatus by a local area network, wide area network, or Internet network. The present invention utilizes discrete sub-systems or sub-assembly components, and associated control of the aforementioned system apparatus and components. The invention is not in the particular detailed configuration of the system apparatus but in the command and control thereof. Accordingly, the data structures, command, control and arrangement of the present invention have, for the most part, been illustrated in the drawings by readily understandable block diagrams. The drawings show only those specific details that are pertinent to the present invention in order not to obscure the disclosure with structural details which will be readily apparent to those skilled in the art having the benefit of the description herein.

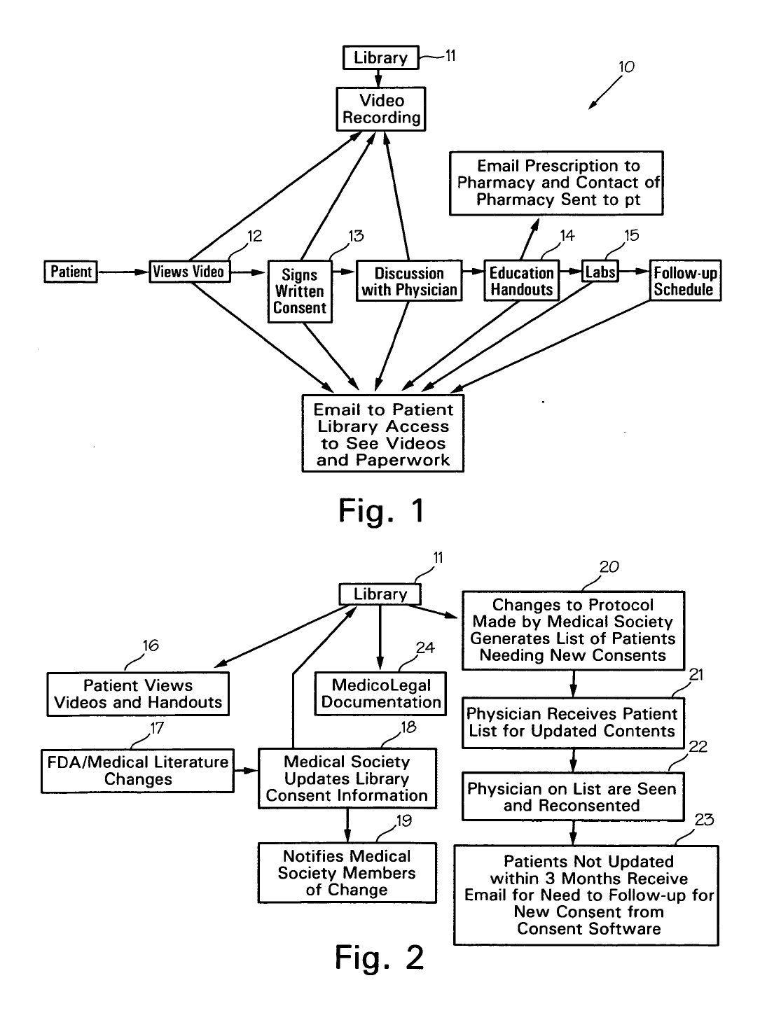

The present invention is a software program FIG. 1, element 10 that resides in the memory of a computer network. The computer network has a server that is in communication with a plurality of client computers. The client computers reside in doctors' offices, clinics, hospitals, universities and personal electronic devices. The server facilitates the command and control of a library or archive 11 of drug and medical/surgical procedure information and the distribution of information to client computers upon request.

For each drug there is a video 12, written consent 13, patient information handouts 14, laboratory flow sheets 15 and orders for the laboratory. For medical/surgical procedures, the server has a video of the medical/surgical procedures, written consent, patient information handouts, laboratory flow sheets and orders for laboratory.

In addition to storing the library of information, the server is also the site where patient videos are maintained. A video of each informed consent process is made documenting the patient watching the video, reading and signing the written consent and the physician interaction with the patient. This information is stored forever to document the patient consent process and the information that was received by the patient. This video documents the standard of care at the time of the drug prescription or medical/surgical procedure, that the patient received this information and that the standard was followed. With informed consents of patients stored electronically, future changes to the standard of care or protocols result in a recall of the patient to re-consent with the new information.

An example of this process is the drug Accutane. The drug Accutane may cause Crohn's disease, inflammatory bowel disease or ulcerative colitis. With the present invention patients whose informed consents did not contain this information would be identified and the physician would be able to notify the patients and obtain a new informed consent with the most recent information available. The patients would re-consent with the latest possible information. This would better inform patients of the side effects of the drug.

Another example is the FDA changes in simvastatin (Zocor), a popular drug for controlling high cholesterol. The FDA has changed the dosing and drug interaction requirements for the medication and currently there is no system that exists for the FDA to contact patients who are taking simvastatin. Systems currently rely on written information sent via mail to physicians and distributed to patients during their visits over the next one to six months. This is an unreliable and slow process resulting in patient injury. The current system would contact all physicians and patients instantly with FDA approved changes, therefore, improving patient safety and limiting medical liability.

In operation: When a patient is placed on a drug, the patient watches a video 12 describing the purpose of the drug, how the drug functions and how the patient will be monitored. A written consent is signed; handouts 16 about the drugs, handouts concerning the visit frequency and labs checked are given. Finally, the patients are sent a link to the server to see all this information at their leisure. The information is delivered through electronic means. An example of the electronic means is a Tablet PC or an F Pad with a built-in video or personal electronic devices.

If changes are made to the FDA/medical literature 17, FIG. 2, by the medical society that maintains the library, it updates the library consent information and notifies medical society members of the change 19. Changes to protocol made by the medical society generate a list of patients requiring new consent forms 20. In response to the list, physicians review their patient list for those needing updated consents 21. Patients on the list are seen and new informed consents are obtained 22. Patients whose consents have not been updated within a specified time receive emails about the need to follow-up for a new informed consent 23. Medical and legal documentation 24 that is generated by the Medical Society is stored in the library for later review by Medical Society members.

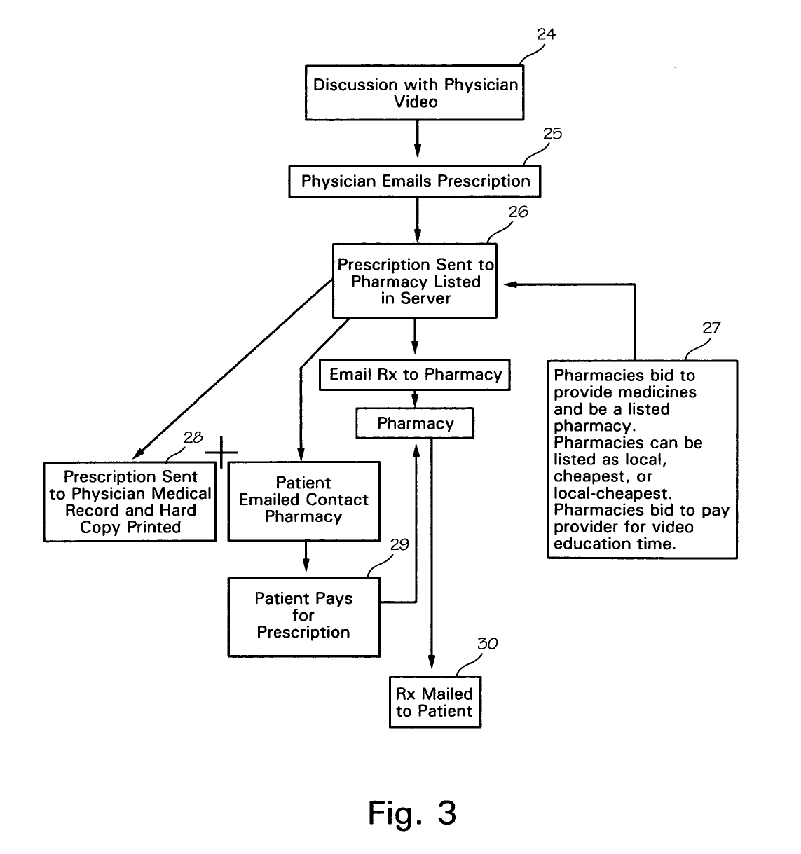

The discussion between the patient and the physician 24, FIG. 3 about the medical condition or drug requirements is video-recorded as part of the informed consent process and stored in the video library 11, FIG. 1. If a prescription for a drug is required it is emailed 25 to a preferred pharmacy 26 for filling or disposition. A list of preferred pharmacies 26 is maintained by the present invention 10. Each member on the list has agreed to have competitive pricing, above average delivery service and to pay the provider for video education time 27, FIG. 3. Further, the prescription is sent to the physician medical record and a hard copy is printed 28. The patient is emailed to contact the pharmacy and pay for the prescription 29. Finally, the prescription is mailed to the patient or disposition 30.

The following two examples present how the present invention functions under normal conditions: A patient presents to a physician with a complaint of a red spot on his arm. The patient is brought into the clinic exam room by a nurse who puts the patient in the exam chair and says that “the physician will be in momentarily”. In the room there is a Tablet PC or other electronic devices that are capable of showing different pictures of the clinic, the staff and may, if desired, have an educational video about the importance of skin protection. After the physician arrives and introduces himself, the patient begins to discuss the reason for the visit. The physician examines the patient's arm where the (red spot) erythematous area is located. The physician is concerned about skin cancer and recommends a biopsy. At this point, the physician would turn on the present invention 10 containing a digital video and audio recording device to record the discussion with the patient of the diagnosis, treatment options and risks, and asking for permission to proceed with the biopsy procedure. Subsequently the patient says “proceed with the biopsy”. The physician turns off the video recorder, performs the biopsy, cauterizes the area and applies a Band-Aid to the area. The physician turns the video recorder back on and tells the patient that the biopsy will be sent for pathology and the patient to come back in several months for a follow-up visit. The physician informs the patient that the nurse will email a video of wound care instructions so they can be reviewed by the patient. The patient is asked if he understands and the patient verbalize understanding. A period of time elapses after the patient leaves, he receives a link to his email and he can look at the video of the physician discussing the diagnosis, informing him of the biopsy procedure and the risks, the patient verbalizes understanding of those risks, and subsequently the physician discussing follow-up care and the nurse's discussion of how to take care of the area.

The next clinical example is the following:

A patient presents with an allergic contact rash. It has been rather severe and it has kept the patient from working at his job. The patient and the physician agree on the need to start a dangerous medicine to control the symptoms. The patient comes into the exam room and the physician examines the patient as was done in the previous example. The physician may, if desired, take a biopsy as before but in this instance the physician sits next to the patient and records the conversation about diagnosis, treatment and the recommendation of a medication called cyclosporine which is an immune suppressive medicine with many side effects requiring strict follow-up with blood tests. The physician turns on the video and the physician says to the patient the “recommendation is cyclosporine. This is a dangerous medicine that has many side effects that are controllable if they are monitored. It is important for the patient to make regular visits to the office.” (A video is available that discusses the risks and benefits of the medication and when the video is concluded the physician returns to the room where the patient and physician discuss everything on the video.) The physician subsequently clicks onto the next icon which has a pre recorded video about the medicine. The patient watches the video with the understanding that he is being video recorded watching the pre-recorded video. At the end of the video, the physician returns and the video recording captures the physician and patient's conversation about the risks and benefits. Subsequently, the physician presses print and there is a transcription of the entire video recording. It also has a summary of how often the physician will see the patient, what blood work will be checked and the risks of the medication. At this point, the patient's questions are answered about the video and the patient goes to get a blood work done and to make an appointment to see the physician in the next week. Immediately after the patient leaves, an email is transmitted to the patient containing a link to a copy of the patient and physician talking, a copy of the pre-recorded video and a copy of all the handouts that the patient received during the visit with the physician.

The video recording is time dated and is populated with the patient's name, date of birth, social security number, email address, the diagnosis, the medication that was given to the patient and the date that the information was given to the patient. The detailed video is stored in the memory of a database. If the Federal Drug Administration (F.D.A.) changes the recommendations or the risks known about the medication, a new video is developed. Through data 20 mining of the database it can be determined which patient received information prior to the new changes. The patient is recalled to the office to see the new pre-recorded video containing the new information. Subsequently an email is sent to the patient or a certified letter if the patient cannot be contacted otherwise.

The information presented to the patient should be in a format that is comprehendible to each unique individual. Prior consent systems assume a level of education or comprehension that is highly variable, which results in most patients feeling uninformed. Most patients are embarrassed to say they do not understand and wait until the physician has left to ask the nurse about a surgery or drug. Many physicians are unable to “get on the same level as a patient.”

When a physician communicates with a patient, it is natural to change the presentation of information based on the unique characteristics (DATA) of each patient. The physician can create the informed consent based on DATA to mirror what is done when a professional normally interacts with people. This will achieve and individualized informed consent. By combining DATA about a patient, a unique consent is created for each patient based on the patient's own characteristics.

Everything about a patient is accessible as DATA, for example:
Name
Date of Birth
Sex
Marital Status
Mailing Address
Employer
Occupation
Language
Parent
Guardian
Level of Education
Medical History
Medications
Disabilities
Email Address
Cell Phone
Who is with patient at visit
Reason for Visit
Where did the patient grow up
Etc

Based on each DATA point, the consent process can be modified to create a unique presentation for each patient.

The concept could apply across all communications in the media and not just medicine. For example, for a student that reads very slowly, it is a challenge to keep pace and comprehend reading material. If the present system could be lain over her history text, the language could be changed to enhance the student's comprehension.

Exemplary applications will be described.

By using a patient's email address, the system can provide the ability to review the informed consent multiple times via additional communication and modify content to fit the medium. By using a patient's cell phone, the system can provide mobile access to the informed consent process and provide consent in appropriate format. By using a patient's disabilities, color blindness for example, the system can provide for a color blind acceptable contrast on all of the display screens. By using a patient's medical history, glaucoma or older age (DOB) e.g., the system can dynamically increase the size of the font on any given screen. By using a patient's ENT reports, a auditory issue or hearing loss patient, the system can increase the sound output for the patient. By using a patient's language, the system can provide for language localization on text and speech content. By using a patient's location or education level, the system can provide education level adjusted content or consent language. By using a patient's occupation, the system can custom tailor some of the discussion points that relate the consent information to the patient more closely (such as example for blue-collar vs white-collar). Similarly, video content can be chosen based on ethnicity to better allow actors to relate to education materials. By using a camera, the system can tell when a patient's looking at the screen, and the system can pause education videos when they are not looking at educational videos. By using the time between patient key strokes, the system can determine concentration and need to modify the program with interruptions or attention mechanisms.

The system can recognize body movements to change message, and the system can recognize clothing and change information delivered. The system can recognize voice patterns of responses to change information delivered.

With this data the software will customize the audio, text, and touch of the system to change the information delivered based on characteristics of the patient. The system will also use the same data to record and monitor the patient response to the questions.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims, means-plus-function clause is intended to cover the structures described herein as performing the recited function and not only structural equivalents but also equivalent structures. Thus, although a nail and a screw may not be structural equivalents in that a nail employs a cylindrical surface to secure wooden parts together whereas a screw employs a helical surface, in the environment of fastening wooden parts, a nail and a screw may be equivalent structures.

1. A method for obtaining informed consent, archiving and updating, the method comprising:
providing a video network integrated with a computer network having a memory;
recording a patient signing of a first informed consent by said video network;
archiving said recording of said signed first informed consent in said memory;
discovering a reason for signing a second informed consent;
updating said second informed consent with at least one parcel of information; and
recording the signing of said second informed consent.

2. A method as recited in claim 1, wherein said step of updating said second informed consent comprises:
obtaining a profile of physician prescribed drug and medical/surgical procedures;
updating said profile with selected information disseminated from an external data source; and
storing said updated profile in said archive.

3. A method as recited m claim 1, wherein said discovering a reason comprises selecting informed consents that lack said updated profile.

4. A method as recited in claim 1, further comprising, prior to said step of recording the patient signing the first informed consent, processing information relating to characteristics of the patient, and modifying the first informed consent according to the patient characteristics.

5. A method as recited in claim 4, wherein the processing step comprises processing the patient characteristics relating to the patient's ability to understand the first informed consent.

6. A method as recited in claim 5, wherein the processing step further comprises processing the patient characteristics relating to at least one of age, sex, marital status, occupation, language spoken, level of education, and disabilities.

7. A method as recited in claim 5, wherein the modifying step comprises creating a unique consent for each patient.

8. A method according to claim 1, wherein the discovering step comprises processing information relating to characteristics of the patient, and wherein the updating step comprises modifying the first informed consent to the second informed consent according to the patient characteristics.

9. A method for obtaining informed consent, archiving and updating, the method comprising:
providing a computer network with memory;
querying said computer network via a computer operated device for a selected informed consent;
obtaining a profile of physician prescribed drug and medical/surgical procedures;
storing said obtained profile on said computer network;
querying said computer network for updated information on said obtained profile;
comparing said obtained profile to said stored profile;
updating said obtained profile with said compared profile;
updating said selected informed consent with said compared profile; and
downloading, upon request, said updated selected informed consent to said computer operated device.

10. A method according to claim 9, further comprising, prior to said step of updating said selected informed consent, processing information relating to characteristics of a patient, and wherein said updating step comprises updating the selected informed consent according to the patient characteristics.

11. A method as recited in claim 10, wherein the processing step comprises processing the patient characteristics relating to the patient's ability to understand the selected informed consent.

12. A method as recited in claim 11, wherein the processing step further comprises processing the patient characteristics relating to at least one of age, sex, marital status, occupation, language spoken, level of education, and disabilities.

13. A method as recited in claim 11, wherein the modifying step comprises creating a unique consent for each patient.

14. A method for obtaining informed consent, archiving and updating, the method comprising:
providing a computer network with memory;
providing said computer network in communication with medical institutions that collect and maintain data on changes in medical/surgical procedures or drugs;
monitoring said computer network for said changes in medical/surgical procedures or drugs;
comparing a first informed consent data to said changes in medical/surgical procedures or drugs, said comparison yielding information to be formulated into a second informed consent;
recording a patient signing said second informed consent; and
storing said signed second informed consent on said computer network with memory.

15. A method as recited in claim 14, further comprising, prior to said step of recording the patient signing the second informed consent, processing information relating to characteristics of the patient, and modifying the second informed consent according to the patient characteristics.

16. A method as recited in claim 15, wherein the processing step comprises processing the patient characteristics relating to the patient's ability to understand the second informed consent.

17. A method as recited in claim 16, wherein the processing step further comprises processing the patient characteristics relating to at least one of age, sex, marital status, occupation, language spoken, level of education, and disabilities.

18. A method as recited in claim 16, wherein the modifying step comprises creating a unique consent for each patient.
